(19) United States
(12) Patent Application Publication
(10) Pub. No.: US 2009/0272953 A1
(43) Pub. Date: Nov. 5, 2009

(54) LIFT APPARATUS

(76) Inventor: Roland Wolf, Palm Coast, FL (US)

Correspondence Address: GRAY ROBINSON, P.A., P.O. Box 2328, FT. LAUDERDALE, FL, 33303-9998, US

(21) Appl. No.: 12/112,036

(22) Filed: Apr. 30, 2008

(51) Int. Cl. B66F 9/065; B66F 3/08

(52) U.S. Cl. 254/7 C; 254/2 C

(57) ABSTRACT

A lift apparatus is provided for loading relatively items into the bed of a truck or van which initially lifts the item to the level of the truck bed and then is simultaneously loaded with the item onto the truck bed so that it can be used for unloading at the destination.

### FIELD OF THE INVENTION

This invention relates to lift apparatus, and, more particularly, to an apparatus for raising and lowering a load from one surface to another wherein the apparatus may be transported with the load.

### BACKGROUND OF THE INVENTION

The transport of items in the bed of trucks or the back of a van can present problems during both the loading and unloading operations. Motorcycles, all-terrain vehicles and other motor-driven equipment typically weigh several hundred pounds, and the most common means of loading these items into a truck bed or the back of a van is a ramp. Depending upon the height of the truck bed or van, the inclination of the ramp can be quite severe and it often takes two or three individuals to perform the loading and unloading operation due to the weight and bulkiness of such vehicles or equipment. Although motor-operated vehicles may be driven along a ramp, that practice can be dangerous and lead to personal injury and/or damage to the vehicle.

Lift apparatus operated manually, pneumatically, hydraulically or by other means are commonly used to vertically move a variety of items. These devices are effective in loading and unloading vehicles and equipment in lieu of ramps, but one problem with current designs is that they are not portable. Unless there is a lift apparatus at the location where the vehicle or equipment is loaded, and then another one at the destination to assist with unloading, such apparatus are of limited use and application for the transport of relatively heavy vehicles and equipment in trucks, vans and the like.

### SUMMARY OF THE INVENTION

The lift apparatus of this invention provides a reliable means of loading relatively heavy vehicles or other equipment into the bed of a truck, van or the like which is portable and travels with such vehicles or equipment so that it can be used for unloading at the destination.

In one presently preferred embodiment, the lift apparatus comprises a base having a number of rollers, a platform for supporting a vehicle, equipment or other load, and a lifting mechanism connected between the platform and base. The lifting mechanism is operative to move the platform and base between an extended position in which they are vertically spaced from another, and a retracted position wherein the platform and base are closely adjacent to one another. Two front supports having rollers at one end may be mounted to the front end of the platform, and two rear supports with rollers at one end may be mounted in a support position to the rear end of the platform when the platform and base are in the extended position. The platform also carries a ramp which may be extended from its rear end to assist with loading.

The lifting mechanism of this invention operates by first placing the platform and base in the retracted position with the platform overlying the base and close to the level of a floor or other surface where the vehicle or equipment to be loaded is located. The ramp is extended and the vehicle or equipment may be easily loaded onto the platform. The lifting device is then operated to move the platform, and the vehicle or equipment is supports, vertically upwardly to the extended position. At this time, the two rear supports may be placed in the support position, i.e. extending vertically downwardly from the rear end of the platform. The rear supports may be provided with a threaded connection or other telescoping arrangement so that the roller at the lower end of each rear support engages the floor. The entire lift apparatus is then rolled to a position wherein the rollers of the two front supports engage a second surface, e.g. the bed of a truck, while the rollers of the two rear supports are in engagement with the floor. At this juncture, the lifting device is activated to move the base away from the floor, in a direction toward the platform, to the retracted position where the platform and base are located closely adjacent to one another. The lifting apparatus may then be rolled on the two front supports and the two rear supports toward the truck so that the rollers of the base engage the truck bed. When the base and platform are substantially entirely on the bed, the two rear supports may be removed from their support position. The reverse of the above-described operation is employed during the unloading operation.

Unlike prior art designs, the lift apparatus of this invention is portable and may be transported with the vehicle, equipment or other object in the bed of a truck, a van or the like. The loading operation may be performed safely and easily because the platform is near the floor when in a retracted position, and the item may be readily unloaded at the destination using the same lift apparatus employed in the loading operation.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a perspective view of the lift apparatus of this invention with the top plate of the platform removed;

FIG. 2 is a side view of the lift apparatus with a ramp extended from the rear, a front support in place and a motorcycle located on the platform;

FIG. 3 is a view similar to FIG. 2 except with the platform in an extended position and a rear support coupled to the rear end of the platform;

FIG. 4 is a view similar to FIG. 3 wherein the lift apparatus is being rolled toward the bed of a truck and the roller of the front support in engagement with the truck tailgate;

FIG. 5 is a view similar to FIG. 4 depicting the lift apparatus being rolled into the bed of the truck;

FIG. 6 is view similar to FIG. 2 with the motorcycle in place on the lift apparatus, which is in the retracted position;

FIG. 7 is a view similar to FIG. 6, except with the lift apparatus in the extended position;

FIG. 8 is a view similar to FIG. 7 wherein front and rear supports are depicted in place at the front and rear of the platform; and

FIG. 9 is a view similar to FIG. 8 showing a wheel mounted to the lift apparatus, and the front and rear supports removed, so that the lift apparatus may be utilized as a trailer to haul the motorcycle.

### DETAILED DESCRIPTION OF THE INVENTION

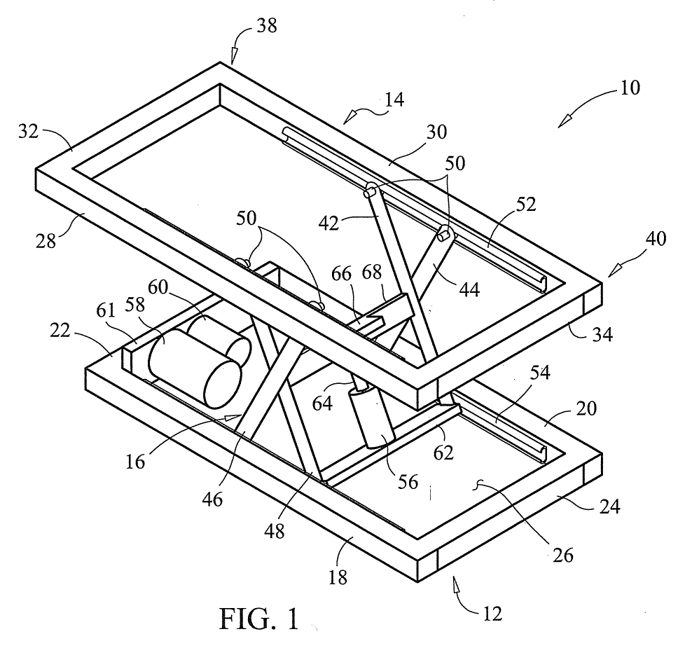

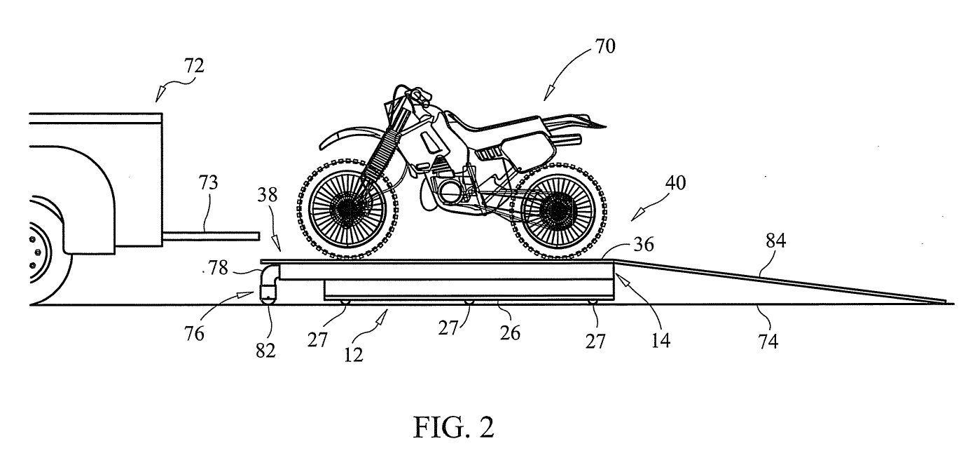

Referring initially to FIG. 1, a lift apparatus 10 according to this invention is schematically depicted. The apparatus 10 comprises a base 12, a platform 14 and a lift mechanism 16 connected between the base 12 and platform 14. As discussed in more detail below, the lift mechanism 16 is operative to move the base 12 and platform 14 vertically relative to one another between a retracted position in which such elements are located closely proximate to one another as depicted in FIG. 2, and an extended position shown in FIG. 1. For purposes of the present discussion, the terms “top,” “bottom,” “upper,” “lower,” “front,” “rear” and the like, refer to the orientation of the lift apparatus 10 as viewed in FIG. 1.

The base 12 includes opposed side beams 18 and 20, and opposed end beams 22 and 24, that are connected at the ends to form a generally rectangular-shaped frame. A bottom plate 26 is connected to the beams 18-24 along their bottom surface to add rigidity to the base 12. As depicted in FIG. 2, a number of rollers 27 are mounted to the bottom plate 26. The platform 14 has a similar construction as that of the base 12. The platform 14 has a generally rectangular-shaped frame defined by opposed side beams 28 and 30 and opposed end beams 32 and 34 that are connected to one another. A top plate 36, shown in FIG. 2, is affixed to the top surface of the beams 28-34 for rigidity and to provide a surface for supporting a vehicle as described below. Preferably, both side beams 28 and 30 of the platform 14 are hollow with openings at the front end 38 and rear end 40 of the lift apparatus 10, for purposes to become apparent below.

As noted above, the lift mechanism 16 is connected between the base 12 and platform 14. A scissors-type, hydraulically operated lift mechanism is depicted in FIG. 1, but it should be understood that other lifting devices and/or other drives, such as pneumatic, screw-operated etc., could be employed to move the base 12 and platform 14 between the extended and retracted positions and are considered within the scope of this invention. The lift mechanism 16 includes a first pair of scissor arms 42 and 44 and a second pair of scissor arms 46 and 48, with both pairs pivotally connected at their centers. The upper end of each scissor arm 42 and 44 mounts a roller 50 that is movable in a longitudinal direction, e.g. front to rear as viewed in FIG. 1, along an upper track 52 mounted to the inside surface of side beam 30. The lower end of each scissor arm 42, 44 is movable in the same fashion via a roller at the lower end thereof (not shown) along a lower track 54 mounted to the inside surface of the side beam 20 of base 12. The scissor arms 46 and 48 are movable along tracks (not shown) mounted to the side beam 18 of base 12 and side beam 28 of platform 14 in the same manner as scissor arms 42 and 44. As the upper and lower ends of the scissor arms 42, 44 and 46, 48 are moved toward one another the base 12 and platform 14 are moved vertically apart to the extended position shown in FIG. 1, and movement of such ends of the scissor arms 42-48 away from one another results in the base 12 and platform 14 moving to the retracted position illustrated in FIG. 2.

The drive for lift mechanism 16 comprises a hydraulic cylinder 56 operatively connected to a pump 58 and a motor 60. The pump 58 and motor 60 may be mounted to a plate 61 connected to the end beam 22 of base 12. The housing of the cylinder 56 is mounted to a lower cross brace 62 connected between the lower ends of scissor arms 42 and 48, and the piston 64 of the cylinder 56 is connected to a plate 66 supported by an upper cross brace 68 extending between the scissor arms 42 and 48. Hydraulic fluid is supplied to the cylinder 56 by the pump 58 and motor 60 to extend and retract its piston 64, and, in turn, extend and retract the scissor arms 42-48, in the conventional manner.

Referring now to FIGS. 2-5, the sequence of operation of the lift apparatus 10 of this invention is shown. For purposes of illustration, a motorcycle 70 is depicted as being loaded into the bed of a pickup truck 72. Initially, the lift mechanism 16 is operated to move the lift apparatus 10 to the retracted position in which the base 12 and platform 14 are closely adjacent to one another near the level of the ground or floor 74. A pair of front supports 76, one of which is shown in FIG. 2, each has an upper end 78 that is inserted into the opening of the side beams 28 and 30 at the front end 38 of the apparatus 10. The lower end of each front support 76 mounts a roller 82. A ramp 84 may be provided to allow the motorcycle 70 to be rolled onto the top plate 36 of the platform 14. Since the apparatus 10 is in the retracted position, the angle of the ramp 84 relative to the floor 74 is shallow and the motorcycle 70 may be easily loaded onto the platform 14 by a single individual.

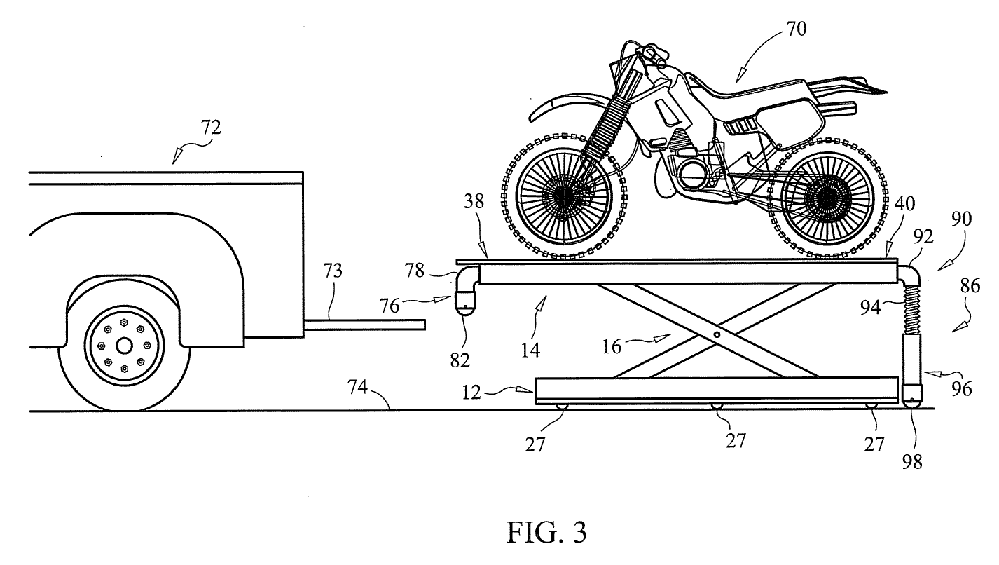

With the motorcycle 70 on the platform 14, the ramp 84 may be removed. The lift mechanism 16 is then activated to move the platform 14 vertically upwardly relative to the base 12, as shown in FIG. 3, so that the roller 82 of each front support 76 is at the same vertical height from the floor 74 as the bed and tailgate 73 of the truck 72. Once in this extended position, a pair or rear supports 86 may be installed at the rear end 40 of the apparatus 10. Each of the rear supports 86, only one of which is shown in the Figs., comprises an upper section 90 having an insert 92 extending at a right angle to a threaded portion 94. The threaded portion 94 is received within an internally threaded lower section 96 of the rear support 86, and a roller 98 is mounted to the free end of the lower section 96. Each rear support 86 is mounted at the rear end 40 of the apparatus 10 by placing the insert 92 into the opening in the side beams 28 and 30 of the platform 14. Because the height of the bed of truck 72 and its tailgate 100 may vary from model to model, vertical adjustment of the rear supports 86 may be necessary to ensure that the rollers 98 contact the floor 74. Such vertical adjustment is obtained by rotating the lower section 96 of the rear supports 86 relative to the threaded portion 94 of the upper section 90. This may be done by hand or with a suitable tool (not shown).

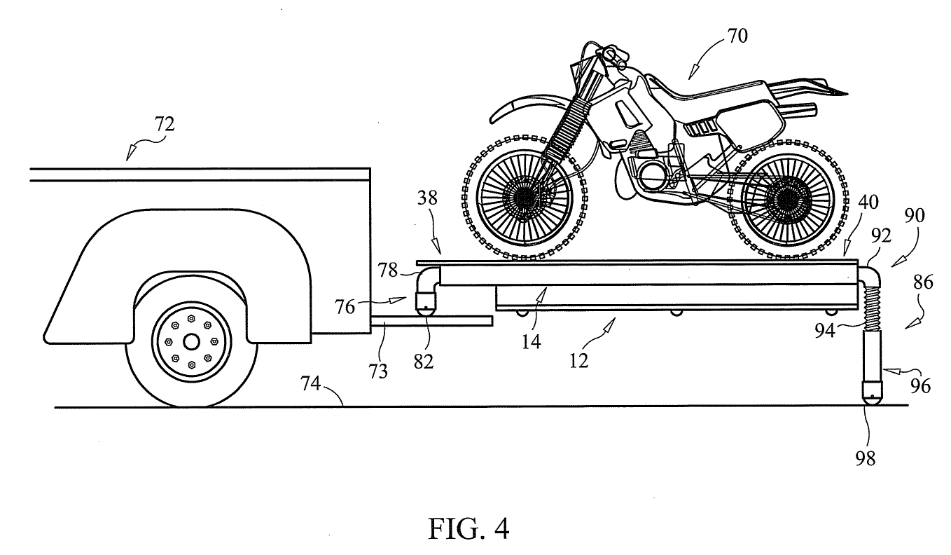

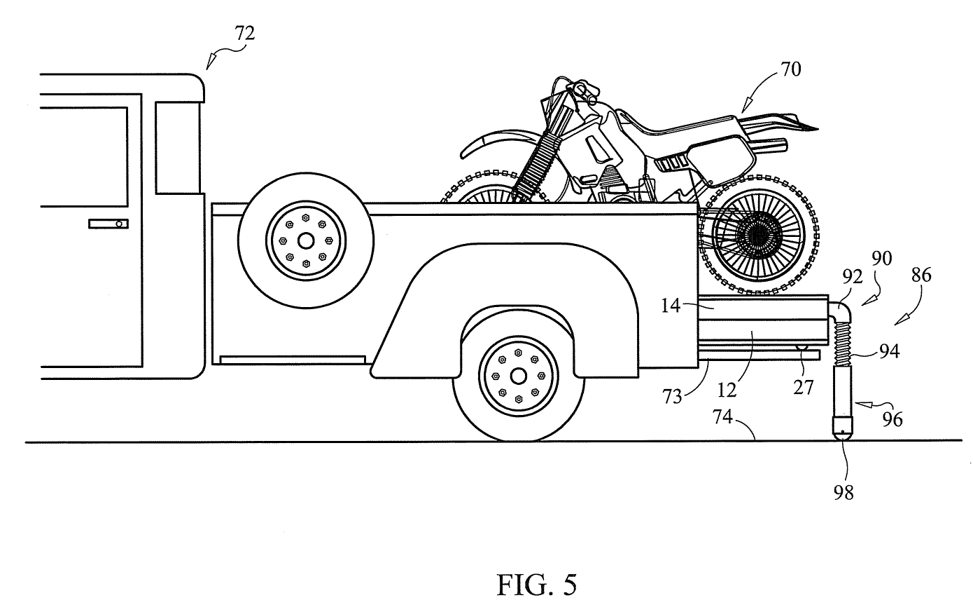

Referring now to FIGS. 3 and 4, with the front supports 76 in place at the front end 38 of the platform 14 and the rear supports 86 mounted at the rear end 40 such that their rollers 98 contact the floor 74, the apparatus may be rolled along the floor 74 on the rollers 27 on the base 12 and the rollers 98 on the rear supports 86. When the roller 82 of each front support 76 contacts the tailgate 73 of the truck 72, all of the weight of the apparatus 10 is supported by the front supports 76 and the rear supports 86. At that point, the lift mechanism 16 is activated causing the base 12 to move vertically upwardly relative to the platform 14 to a retracted position depicted in FIG. 4. The base 12 moves relative to the platform 14 because the platform 14 is held in place by engagement of the front supports 76 with the tailgate 73 and the rear supports 86 with the floor 74. In this retracted position, the apparatus 10 may be rolled toward the truck 72 on the rollers 82 of the front supports 76 and the rollers 98 of the rear supports 86. Once the base 12 reaches the truck 72, its rollers 27 engage the tailgate 73 and roll along it into the truck bed. See FIG. 5. When the weight of the apparatus 10 is supported by the truck 72, the rear supports 86 may be removed from the rear end 40 of the platform 14 allowing the apparatus 10, and the motorcycle 70 it supports, to be entirely received within the truck bed.

The loading process of this invention described above is simply reversed in order to unload the motorcycle 70 from the truck 72. The apparatus 10 is moved toward the tailgate 73 until the rear supports 86 may be inserted into the side beams 28 and 30 of platform 14, as discussed above, and such movement continues until the base 12 clears the tailgate 73 while the front supports 76 remain in contact with the truck bed or its tailgate 73. See FIG. 4. At this juncture, the lift mechanism 16 is activated to cause the base 12 to move vertically downwardly into engagement with the floor 74. With the weight of the apparatus 10 and motorcycle 70 now carried by the platform 14, lift mechanism 16 and base 12, the rear supports 86 and the front supports 76 may be removed. The lift mechanism 16 is then activated again to cause the platform 14 to move vertically downwardly into a retracted position relative to the base 12, as depicted in FIG. 2. The motorcycle 70 may be unloaded from the apparatus 10 along the ramp 84 in the same manner as it was initially loaded.

The lift apparatus 10 of this invention is therefore operative by first causing the platform 14 to move vertically upwardly relative to the base 12 when the base 12 is on the floor 74, and then to move the base 12 vertically upwardly relative to the platform 14 when the platform 14 is in the extended position and supported at both ends by the front supports 76 and the rear supports 86. Unlike prior lift devices, the lift apparatus 10 herein may be transported with the motorcycle 70 on the truck 72, and then utilized to unload the motorcycle 70 at the destination to ensure both safe loading and unloading.

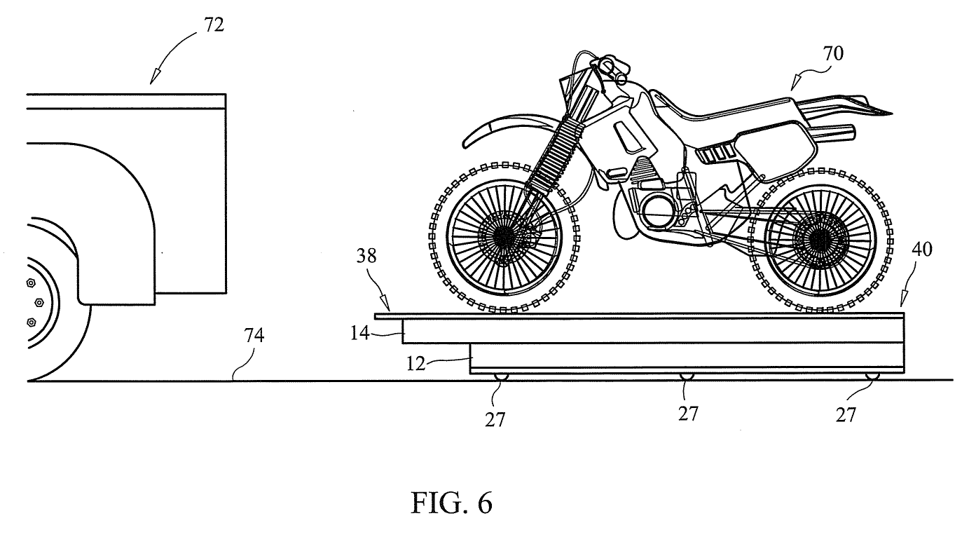

Referring now to FIGS. 6-9, an alternative embodiment of this invention is shown in which the lift apparatus 10 is made to function as a trailer 100 which may be hooked to the truck 72 instead of requiring loading of the motorcycle 70 into the truck bed. The structure and operation of the lift apparatus 10 is the same as that described above in connection with a discussion of FIGS. 1-5, except as noted below.

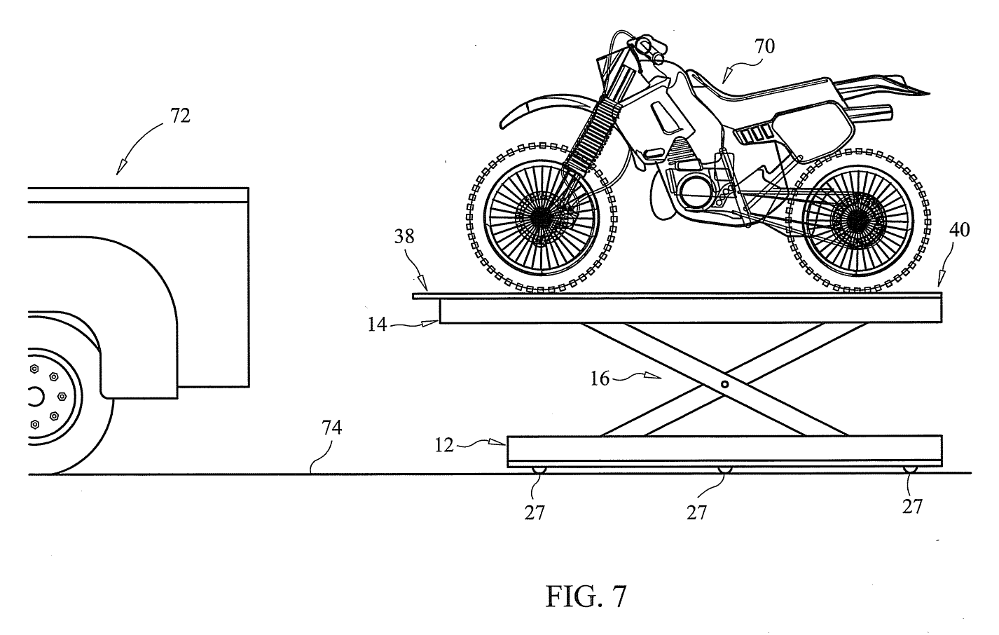

Initially, the motorcycle 70 is loaded onto the apparatus 10 in the same manner as described above and depicted in FIG. 2. The lift mechanism 16 is operated to move the platform 14 and motorcycle 70 vertically upwardly relative to the base 12 which is located on the floor 74. See FIG. 7. With the scissor arms 42-48 extended as shown in FIG. 7, a pair of front supports 102 and a pair of rear supports 104 are inserted into respective openings in the side beams 28 and 30 of the platform 14 at the front end 38 and rear end 40 thereof. Only one of each of the front supports 102 and rear supports 104 is shown for ease of illustration. The front and rear supports 102, 104 have the same construction, and each comprises an upper portion 106 having an insert 108 joined with a threaded section 110, and a lower portion 112. The lower portion 112 is internally threaded to receive the threaded section 110 of the upper portion 106, and a roller 114 is mounted at the free end of lower portion 112. Vertical adjustment of the front and rear supports 102, 104 is obtained in the same manner as front and rear supports 76, 86 discussed above.

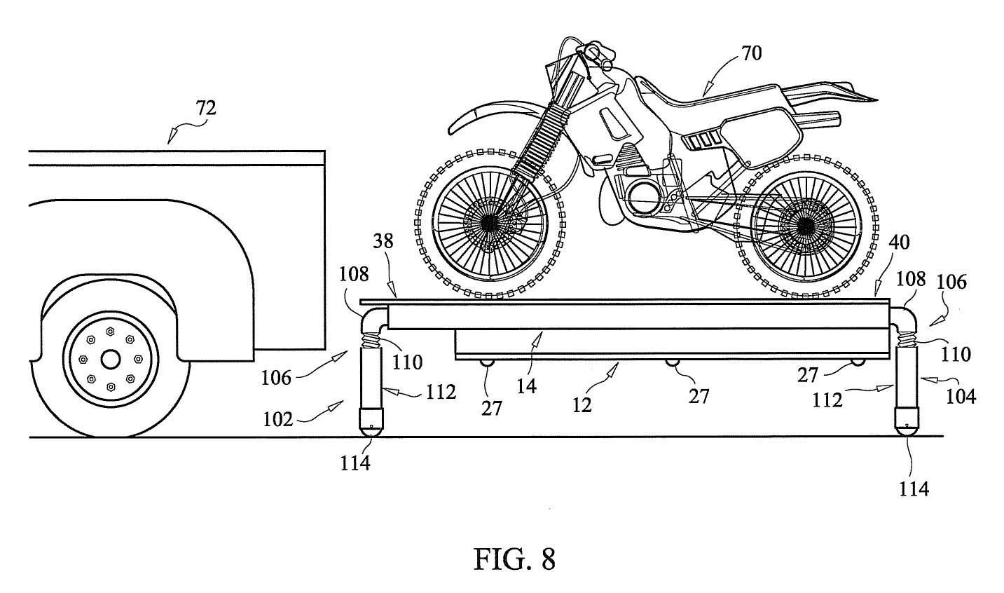

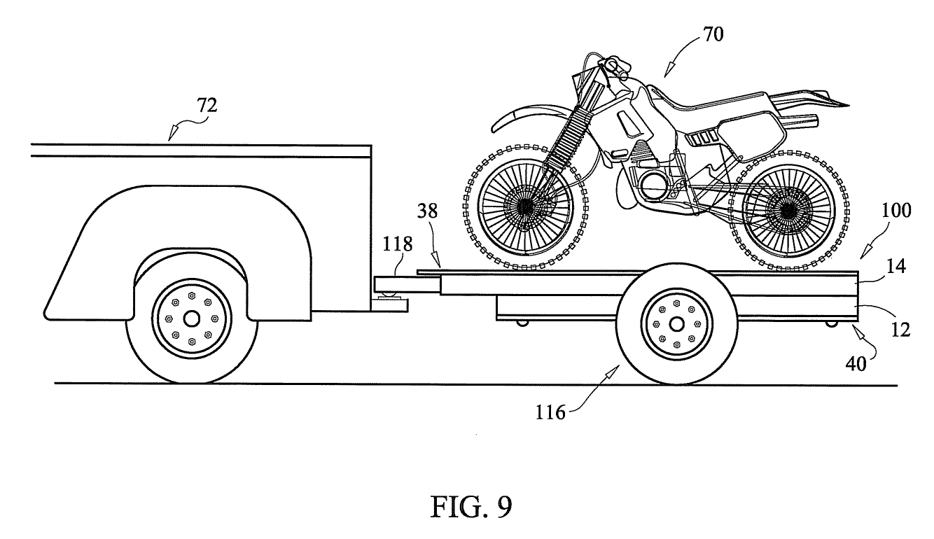

With the front and rear supports 102 and 104 bearing the weight of the apparatus 10, the lift mechanism 16 is activated to move the base 12 vertically upwardly to a retracted position relative to the platform 14 as shown in FIG. 8. A wheel assembly 116 may then be mounted to the base 12. See FIG. 9. Front and rear supports 102, 104 may be adjusted vertically first to accommodate the height of the wheel assembly 116 to permit its installation, and then to lower the apparatus 10 downwardly onto the wheel assembly 116. After the wheel assembly 116 is installed, the front and rear supports 102 and 104 may be removed from the platform 14 and the trailer 100 is thus complete. A hitch 118 may be provided at the front end 38 of the base 12 for connection to the truck 72. The operations described above are simply reversed to convert the trailer 100 back to the lift apparatus 10 and unload the motorcycle 70.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof.

For example, while a motorcycle 70 is shown in the drawings and described herein, it should be understood that the lift apparatus 10 of this invention may be used with essentially any vehicle or other object that may be transported by a truck, van or the like. Additionally, the lift apparatus 10 may be employed to transport an object from a first surface such as floor 74 to a vertically higher, second surface where there is no ramp, or where the ramp to such higher second surface is steep, or where the object has no rollers or other means to facilitate movement along a surface. Because the base 12 includes rollers 27, an object placed on the apparatus 10 may be readily moved along essentially any surface and lifted upwardly and/or downwardly from one surface to another surface wherein such surfaces have different heights.

Therefore, it is intended that the invention not be limited to the particular embodiment disclosed as the best mode contemplated for carrying out this invention, but that the invention will include all embodiments falling within the scope of the appended claims.

What is claimed is:

1. A lift apparatus, comprising:
a base adapted to move along a first surface, and to move along a second surface that is vertically spaced above the first surface;
a platform having a front end and a rear end;
a lift mechanism connected between said platform and said base, said lift mechanism being moveable between an extended position in which said platform and said base are vertically spaced from one another and a retracted position in which said platform and said base are located adjacent to one another;
at least one front support having a first end coupled to said front end of said platform and a second end adapted to move along the second surface;
at least one rear support having a first end and a second end, said at least one rear support being positionable in a support position with said platform and said base in said extended position wherein said first end of said at least one rear support is coupled to said rear end of said platform and said second end is moveable along the first surface;
whereby when said second end of said at least one front support engages the second surface, with said at least one rear support in said support position, said lifting mechanism is operative to move said base away from the first surface in a direction toward said platform to said retracted position thereof, said second end of said at least one front support and said base thereafter being movable along the second surface while said second end of said at least one rear support moves along the first surface, said at least one rear support being removable from said support position with said base resting on the second surface.

2. The lift apparatus of claim 1 in which said base is movable along the second surface when said platform and said base are in said retracted position and when said at least one rear support is in said support position.

3. The lift apparatus of claim 2 in which said at least one rear support may be uncoupled from said platform when said base is located on the second surface.

4. The lift apparatus of claim 1 in which said second end of said at least one front support and said second end of said at least one rear support are vertically spaced from one another a distance that is substantially equal to said vertical space between the first and second surfaces.

5. The lift apparatus of claim 1 in which said at least one rear support has a height dimension, said at least one rear support being vertically adjustable to vary said height dimension.

6. The lift apparatus of claim 1 further including a ramp coupled to said rear end of said platform.

7. The lift apparatus of claim 1 in which a number of rollers are mounted to said base to permit motion along the first and second surfaces.

8. The lift apparatus of claim 1 in which a roller is mounted to said second end of said at least one front support.

9. The lift apparatus of claim 1 in which a roller is mounted to said second end of said at least one rear support.

10. A lift apparatus, comprising:
a base adapted to move along a first surface, and to move along a second surface that is vertically spaced above the first surface;
a platform having a front end and a rear end;
a lift mechanism connected between said platform and said base, said lift mechanism being moveable between an extended position in which said platform and said base are vertically spaced from one another and a retracted position in which said platform and said base are located adjacent to one another.
a pair of front supports each having a first end coupled to said front end of said platform and a second end that mounts a roller, said rollers being moveable along the second surface;
a pair of rear supports each having a first end and a second end that mounts a roller, said rear supports being positionable in a support position wherein said first end is coupled to said rear end of said platform and said roller of said second end contacts the first surface;
said lift mechanism being initially operative to move said platform and said base to an extended position in which said base rests on the first surface, said platform is vertically spaced from said base and said rear supports are coupled in said support position to said rear end of said platform, said base and said rear supports being movable along the first surface so that said rollers mounted to said second end of said front supports contact the second surface, said lifting mechanism thereafter being operative to move said base in a direction toward said platform to said retracted position of said platform and said base thereby permitting said rollers of said base and said rollers mounted to said second end of said front supports to engage and move along the second surface while said rollers of said rear supports move along the first surface, said rear supports being uncoupled from said platform when said base rests on the second surface.

11. The lift apparatus of claim 10 in which each of said rear supports has a height dimension, said rear supports being vertically adjustable to vary said height dimension.

12. The lift apparatus of claim 10 further including a ramp coupled to said rear end of said platform.

13. The lift apparatus of claim 10 in which each of said rear supports includes an upper section and a lower section, said upper section having an insert and a threaded portion, said lower section having an end that mounts a roller and an internally threaded portion to receive said threaded portion of said upper section, said insert of said upper section being coupled to said rear end of said platform.

14. A lift and trailer apparatus, comprising:
a base;
a platform having a front end and a rear end;
a lift mechanism connected between said platform and said base, said lift mechanism being moveable between an extended position in which said platform and said base are vertically spaced from one another and a retracted position in which said platform and said base are located adjacent to one another.
a pair of front support each having a first end and a second end that mounts a roller, said front supports being positionable in a support position wherein said first end is coupled to said front end of said platform and said roller contacts a first surface;
a pair of rear supports each having a first end and a second end that mounts a roller, said rear supports being positionable in a support position wherein said first end is coupled to said rear end of said platform and said roller contacts the first surface;
said lift mechanism being initially operative to move said platform and said base to an extended position with said base resting on the first surface and said platform vertically spaced from said base, said front supports and said rear supports being coupled to respective front and rear ends of said platform in said support positions, said lifting mechanism thereafter being operative to move said base in a direction toward said platform to said retracted position of said platform and said base;
a wheel assembly being coupled to said base with said base in said retracted position and said front and rear supports in said support position, said front and rear supports thereafter being uncoupled from said platform and said base, platform and wheel assembly thereby collectively forming a trailer.

15. The lift apparatus of claim 14 in which each of said rear supports has a height dimension, said supports being vertically adjustable to vary said height dimension.

16. The lift apparatus of claim 14 in which each of said front support and rear supports includes an upper section and a lower section, said upper section having an insert and a threaded portion, said lower section having an end that mounts a roller and an internally threaded portion to receive said threaded portion of said upper section, said insert of said upper section of said rear supports being coupled to said rear end of said platform and said insert of said upper section of said front supports being coupled to said front end of said platform.
